(19) United States
(12) Patent Application Publication
(10) Pub. No.: US 2015/0149149 A1
(43) Pub. Date: May 28, 2015

(54) SYSTEM AND METHOD FOR TRANSLATION

(71) Applicant: SpeechTrans Inc., Lyndhurst, NY (US)

(72) Inventors: John Frei, Point Pleasant Beach, NJ (US); Yan Auerbach, Hartsdale, NY (US)

(21) Appl. No.: 14/612,950

(22) Filed: Feb. 3, 2015

Related U.S. Application Data
(62) Division of application No. 13/541,231, filed on Jul. 3, 2012.
Application No. 13/541,231 is a continuation-in-part of application No. 13/152,500, filed on Jun. 3, 2011, now abandoned.
(60) Provisional application No. 61/351,775, filed on Jun. 4, 2010.

(51) Int. Cl. G06F 17/28

(52) U.S. Cl. CPC G06F 17/2854; G06F 17/289
USPC 704/5

(57) ABSTRACT

A system and method of improving a translation system are disclosed, in which the method may include presenting initial text in a source language and a corresponding translation text sequence in a target language, to a user on a computing device; prompting the user to propose alternative text for at least a portion of the translation text sequence; receiving proposed alternative translation text from the user; assigning a rating, by the user, to the proposed alternative translation text; and storing the received proposed translation text in a database.

### CROSS-REFERENCE TO RELATED APPLICATIONS

This application is a Divisional application of U.S. Non-Provisional application Ser. No. 13/541,231, filed Jul. 3, 2012, entitled “System and Method for Translation” [Attorney Docket 2955-002U52], the entire disclosure of which is incorporated herein by reference.

U.S. Non-Provisional application Ser. No. 13/541,231 is a Continuation-In-Part application of U.S. Non-Provisional application Ser. No. 13/152,500, filed Jun. 3, 2011, entitled “System and Method for Translation” [Attorney Docket 2955-002U51], which application in turn claims the benefit of U.S. Provisional Patent Application Ser. No. 61/351,775 filed Jun. 4, 2010, entitled “Speechtrans™ Translation Software Which Takes Spoken Language and Translates to Another Spoken Language,” the disclosures of which applications are incorporated herein by reference in their entirety.

### BACKGROUND OF THE INVENTION

In the existing art, translation of text from one language to another involves the use of dictionaries to translate on a word-by-word basis. This approach is slow and subject to inaccuracies arising from a lack of context for the individual words being translated. Moreover, the archive of available translations is generally stagnant over extended periods, leading sub-optimal translations of modern terms and phrases.

Accordingly, there is a need in the art for an improved system and method for translating between two languages.

### SUMMARY OF THE INVENTION

According to one aspect, the present invention is directed to a method of improving a translation system, wherein the method may include presenting initial text in a source language and a corresponding translation text sequence in a target language, to a user on a computing device; prompting the user to propose alternative text for at least a portion of the translation text sequence; receiving proposed alternative translation text from the user; assigning a rating, by the user, to the proposed alternative translation text; and storing the received proposed translation text in a database.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a block diagram of a system for speech to speech translation in accordance with an embodiment of the present invention;

FIG. 2 is a block diagram showing an example of the operation of an embodiment of the present invention;

FIG. 3 is a block diagram of a computer system useable in conjunction with one or more embodiments of the present invention;

FIG. 4 is a block diagram of a system for conducting speech to speech translation in accordance with an embodiment of the present invention;

FIG. 5 is a block diagram of a teleconferencing system in accordance with an embodiment of the present invention; and

FIG. 6 is a flow diagram of a method for updating translations in a database in accordance with an embodiment of the present invention.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to phrases such as “one embodiment” or “an embodiment” means that a particular feature, structure or characteristic described in connection with the embodiment is included in at least one embodiment of the invention. The appearances of phrases such as “in one embodiment” or “in an embodiment” in various places in the specification do not necessarily all refer to the same embodiment.

One embodiment receives spoken language and translates to another spoken language.

An embodiment of the present invention relates to translation software, which takes spoken language and translates to another spoken language.

Currently, people tend to communicate using hard-copy dictionaries, electronic dictionaries, or learning new languages in their entirety. The present invention offers easy interaction with others who speak a different language which is that are not currently available.

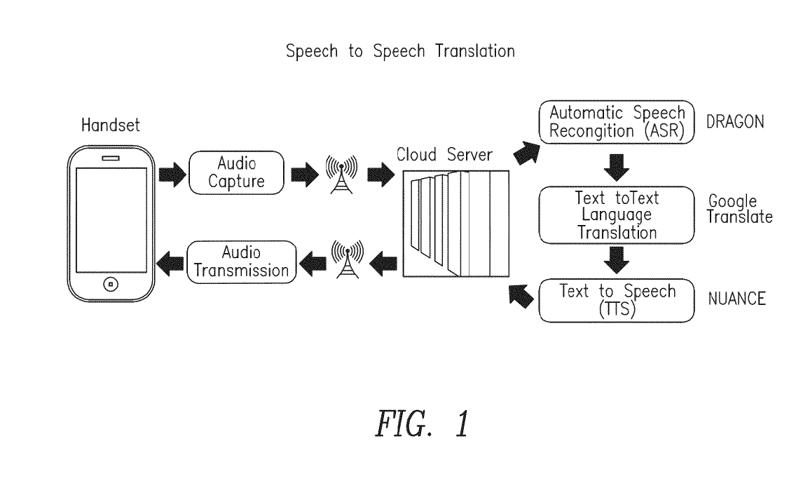

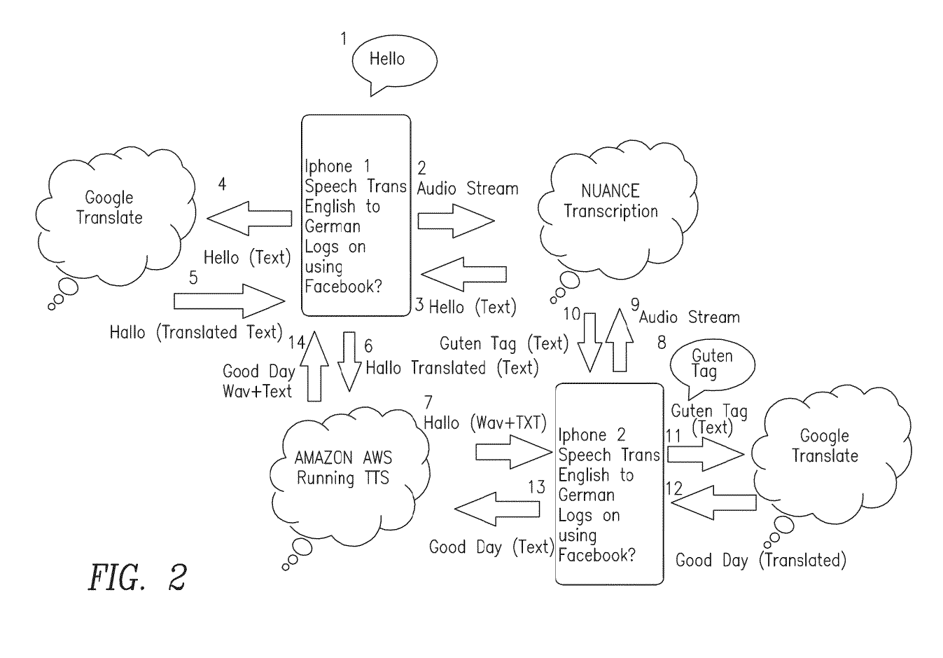

Please refer to FIGS. 1 and 2 in connection with the reference numerals used below, in which each reference numeral corresponds to a separate step. The steps may include: 4 Informing; 6 Inquiring; 8 Providing; 10 Language Selection; 12 First decision; 14 Language Translation; Language Translation; a second decision; and/or additional translation options such as different dialects, email recording, email translation results, viewing alternate translations, sending translations as text messages, posting translations to Facebook®, posting translations to Twitter®, or replaying audio streams of translated text.

The method 2 describes a method of spoken language translation based on an input from a user (translator) and receiver (translatee).

A method according to one embodiment can include at least three steps which are listed below. The invention is not limited to performing the steps in any particular order.

Step A—Automatic Speech Recognition (ASR).

Step B—Text to Text Translation.

Step C—Text to Speech (TTS) conversion.

A method according to one embodiment may include the following steps:

Step 1—Speechtrans™ software is downloaded onto a smart phone.

Step 2—Speechtrans™ software is opened on the Smart phone.

Step 3—Push and release the record button to active the microphone recording.

Step 4—Push the Stop button once done with speaking desired sentence or sentences desired for translation.

Step 5—Spoken Language is then sent to a Cloud Server in order for Automatic Speech Recognition (ASR) to transcribe the spoken language to text.

Step 6—The Text is then translated from the selected language into the desired language.

Step 7—Text, translated Text and Text to Speech (TTS) data is sent back to the smart phone.

Step 8—Steps 3-7 are repeated with Translatee and Translator alternating turns.

In the step of Informing 4, a user of the present method (such as a business person, tourist or student utilizing a Smart Phone, Feature Phone or Landline and SpeechTrans' InterprePhone service) interacts with a receiver—a person who speaks a foreign language (such as a business person or native to the country the tourist is visiting) by pushing and releasing a button on their smart phone to start the translation process. Pressing the “stop” button may operate to stop the Automatic Speech Recognition (ASR) and start the Translation process. The spoken language is identified and displayed as text at the top of the Screen along with the translated text being displayed at the bottom of the screen. This step may be performed through any means of transmitting information known in the art, such as through a verbal signal, a written signal (e.g., a menu), an electronic signal (e.g., email), a visual signal (e.g., a photo or a video monitor), etc. Further, this step is not limited to offering merely one option. For example, the user may offer the business person or native as few as two language choices, with no upper limit on choices, but preferably not more than five choices.

In the step of Inquiring 6, the user of the method may ask the translatee what language he or she prefers among the choices offered, and may then confirm the translatee's response. The user could make this inquiry in any known manner, such as by asking the translatee his preference and then listening for a vocal response, by providing a selection option on the phone upon which the consumer can make a written response, and/or by providing an electronic data entry input device (e.g., mouse, microphone, video camera, keyboard, and/or touchpad.) The step of Informing 4 may be omitted if a translatee already knows her options, such as by being served by the translator on a previous occasion.

In one embodiment, the translatee only has two choices, such as English to German and English to Spanish, in which case First Decision 12 may be omitted. Other embodiments including cases in which the translatee can only choose between English to Chinese and French to German or Spanish to Italian and Danish to Swedish with corresponding changes to the flow diagram. In another embodiment, the translatee may be given more than three options, such as an additional option of English to German with a Swiss Dialect, with corresponding changes to the flow diagram.

In another embodiment, the method could include translating text or speech into a Language presumed to be that of the Translatee, and asking the Translatee for Confirmation. If the Translatee does not provide a confirmation, the translator may then ask which language or dialect to translate the text or speech into. Based on the received information, the translator may then continue to conduct translation from English into a desired target Language, add various dialects, use various different speech patterns (that of a woman or a man, etc.), and/or start the language detection software to help identify the desired Language for the translatee.

Chronological order is shown in the flow diagram of FIG. 2. The process preferably begins at the step of Informing 4 and ends at the step of Language Translation 14. As shown in the diagram, the step of Informing 4 preferably occurs before the step of Inquiring 6, which preferably occurs before the step of Providing 8, and so forth. However, the order of many of these steps may be changed. By way of example, but not limitation, the step of Providing 8 may occur during or before the step of Informing 4 or during or before the step of Inquiring 6. Further, even the step of Language Selection 10 could occur during or before either or both of the steps of Informing 4 and Inquiring 6, as long as sufficient time remains to make the proper decisions in First and Second Decisions 12, 18.

In another embodiment, the steps of Language Selection 10, Language Translation, and/or additional translation options (described above) could be altered or adjusted so that, if the preference indicated in the step of Language Selection 10 is English to Chinese, the Translation occurs with ability to modify the process so as to include dialect variations within the additional translation options, which were discussed previously herein.

As another example, the embodiment shown may be implemented by a computer and/or a machine. However, a human (e.g., business person, tourist) may not appear to execute the steps and decisions in the formal manner shown. For example, after the step of Inquiring 6, a human may make a decision to execute the steps along one of three different flow paths, each path corresponding to a preference indicated by the translatee. A first path, corresponding to English to German, may include these steps, in order: Language Selection 10—select English to German Translation on smart phone enabled with Speechtrans™ Translation Software; pushing and releasing the speech button on the smart phone to recognize spoken language in English, pushing stop once finished speaking, which automatically Translates English to German. Await Translatee confirmation of understanding and push record button on smart phone to enable the Translatee to translate spoken German into English.

The method works as follows. When a translatee is informed in the step of Informing 4 about his choices, he then forms a preference among those choices. This preference is subsequently revealed to the translator in the step of Inquiring 6, when the translator inquires about the translatee's preference and the translatee provides the translator with preference information. Before, during, or after these steps, the translator executes the step of Providing 8 by providing tools (Smart Phone, Speechtrans™ Translation Software, Visual Display, GPS, etc) for producing the Speech Recognition, Translation and Audio Output preferred by the translatee. Subsequently, the translator performs the Language Selection 10 step by selecting the desired language in the Cell Phone Translation Software Menu.

If the translatee opts for English to Spanish, then the translator in First Decision 12 will proceed to the step of Language Selection 10, in which he selects Spanish in the Translation Software Menu. If the translatee opts for something other than Spanish, then the translator in First Decision 12 will proceed to the step of Language Detection, in which he may use the smart Phone, Language Translation Software, Visual Display, etc. to determine the appropriate Language to use, in which the Dialect can be identified among the additional translation options to ensure proper Language Translation. Then, if the translatee opts for French, then the user in Second Decision 18 will proceed to the step of Language Translation 14, described previously. If, instead, the consumer opts for Portuguese, then the user in Second Decision 18 will proceed to the step of Language Selection 10, in which he will continue to identify the appropriate Language. After this step, the translator will proceed to the step of Language Translation 14, after which the process ends.

A Translator may download the software to a smart phone device to implement a method according to the present invention. Such a smart Phone may include an information output device (such as a monitor or display), an information input device (such as a keyboard, touchpad, or microphone), and the mechanical means to translate from one language to another according to the preference of a translatee.

The available choices for Language Translation could be presented to a translatee via the information output device. The translatee could then express a preference regarding his Language Selection via the information input device. Based on this information, the Language Translation Software could then Translate Desired Languages on the translatee's input.

The Language Translation could then be provided to the translatee via audio output, visual output, and/or tactile output. The method could be used by any person or machine that is in need of Language Translation.

In a different field of technology, the field of learning a new Language, a Language Learning system may implement a variation of the method by presenting the available Language choices to the Student, receiving preference information, and then teaching a specific Language to the Student based on this information.

Thus, various of the concepts discussed herein may be applied to: Language Translation, Learning a new Language, Communication with any person in the World, potential for inter-species communication.

In one embodiment, the Process of Language Translation and repetition would enable both the Translator and the Translatee to benefit from direct Language Translation as a means of communication whereas without, communication would be extremely difficult.

In one embodiment, this invention may eliminate language barriers. Downloadable software to a smart phone can allow full translation from spoken language to another spoken language, allowing people who speak different languages to communicate with each other in their native language. By using the latest in Automatic Speech Recognition (ASR), Language translation and Text to Speech (TTS) it allows users to speak in their native language and the software does the translation.

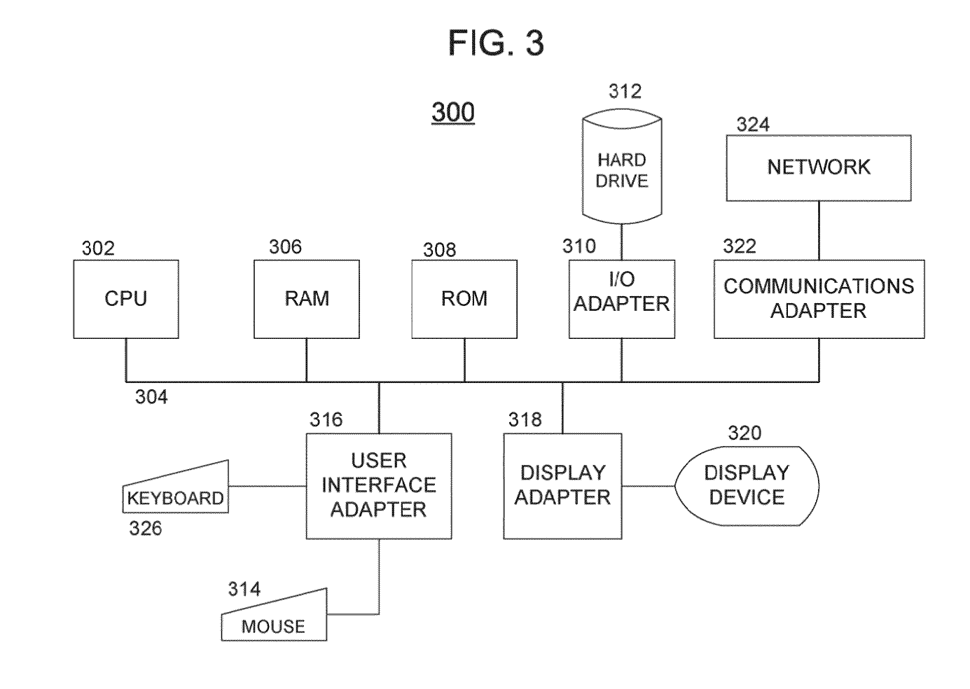

FIG. 3 is a block diagram of a computing system 300 adaptable for use with one or more embodiments of the present invention. Central processing unit (CPU) 302 may be coupled to bus 304. In addition, bus 304 may be coupled to random access memory (RAM) 306, read only memory (ROM) 308, input/output (I/O) adapter 310, communications adapter 322, user interface adapter 306, and display adapter 318.

In an embodiment, RAM 306 and/or ROM 308 may hold user data, system data, and/or programs. I/O adapter 310 may connect storage devices, such as hard drive 312, a CD-ROM (not shown), or other mass storage device to computing system 300. Communications adapter 322 may couple computing system 300 to a local, wide-area, or global network 324. User interface adapter 316 may couple user input devices, such as keyboard 326, scanner 328 and/or pointing device 314, to computing system 300. Moreover, display adapter 318 may be driven by CPU 302 to control the display on display device 320. CPU 302 may be any general purpose CPU.

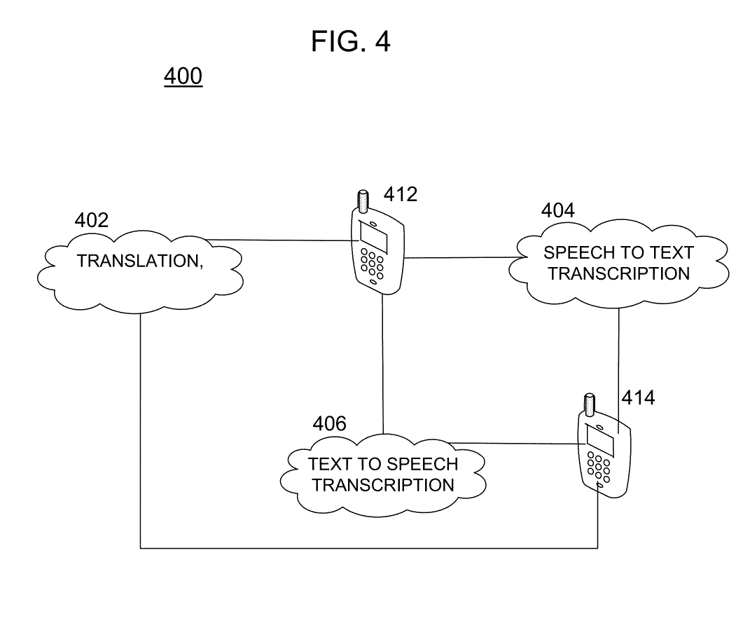

FIG. 4 is a block diagram of a system 400 for conducting speech to speech translation in accordance with an embodiment of the present invention. System 400 may include communication device 412 (which may be a smartphone or other device capable of running suitable software and communicating with the external entities that may perform selected functions described herein); communication device 414, translation engine 402, speech to text (STT) transcription engine 404, and/or text to speech (TTS) transcription engine 4-6. In one embodiment, the function of translation engine 402 may be provided by Google®, SpeechTrans TTS translation engine, or other suitable translation service. The speech to text transcription function of engine 404 may be provided by Nuance Communications Inc., or any other speech-to-text provider. The text to speech transcription function of engine 406 may be provided by the Amazon® AWS TTS database, SpeechTrans TTS database, or other suitable text-to-speech service. However, the present invention is not limited to using the above-listed services for translation and transcription. The translation and transcription engines may be cloud-based, and may thus be in any locations that are Internet-accessible. Moreover, the respective locations of the translation and transcription engines need not be fixed, but may instead be mobile to any node on the Internet to which communication access is available by mobile communication devices and the telecommunication services associated with the mobile devices.

An example of speech to speech translation is now considered. In this example, an exchange of a basic greeting between a first user who speaks English and a second speaker who speaks German is considered. An English-speaking user (user 1) may speak the phrase “hello” into device 412. Thereafter, device 412 may send an audio file (such as a WAV file) representing the spoken phrase “hello” to STT transcription engine 404. Engine 404 may then transcribe the WAV file into text and send the resulting text file, with the text version of “hello” back to device 412.

Device 412 may then send the text file arising from the transcription in engine 404 to translation engine 402. Translation engine 402 may then translate the English-language text file into German. The translated version of “Hello” may then be sent to TTS transcription engine 406 for conversion into German-language speech. Thereafter, transcription engine 406 may send a WAV file with the German version of “Hello” to communication device 414. Communication device 414 may then play the WAV file to a German-speaking user (user 2). In this example, user 2 responds by speaking the German phrase “Guten Tag” into communication device 414. Thereafter, device 414 may send the resulting WAV file of the spoken phrase “Guten Tag” to STT transcription engine 404. Thereafter, STT engine 404 may send the resulting text file to device 414.

Communication device 414 may then send the text file to translation engine 402 to translate the text file with the text “Guten Tag” into the English phrase “Good Day”. Thereafter, translation engine 402 may send the text file for “Good day” to device 414. Device 414 may then send the translated text file to TTS engine 406 where engine 406 may convert the text file into a WAV file with the spoken text “Good day”. TTS engine 406 may then send the WAV file of “Good day” to device 412, whereupon device 412 may play the WAV file of “Good day” for user 1. This last step preferably completes one example of speech to speech translation employing one embodiment of the present invention.

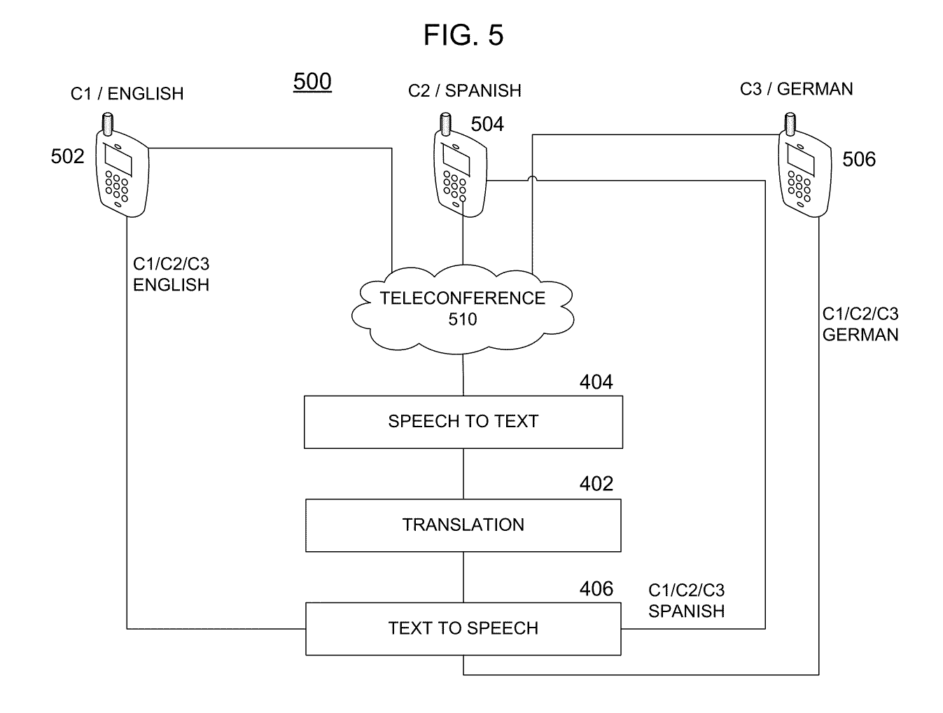

FIG. 5 is a block diagram of a teleconferencing system 500 in accordance with an embodiment of the present invention. System 500 may include communication devices 502, 504, and 506; speech to text (STT) transcription engine 404, translation engine 402; and/or text to speech (TTS) engine 406. In one respect, teleconferencing system 500 may be thought of as a particular application of system 400 which need not require hardware in excess of that disclosed elsewhere herein.

In the following, an exemplary use of the system 500 is described. In the example, conferee 1 speaks English, conferee 2 speaks Spanish, and conferee 3 speaks German, and all participate in a common teleconference 510. The three conferees, C1, C2, and C3 may be co-located, or may be located anywhere in the world that is accessible by telecommunication services that can link the conference participants to teleconference 510. In the following, a selected sequence of speech, translation, and playback to the conferees is described. However, it will be appreciated that a range of alternative sequences of speech and reception could take place, and that all such variations are intended to be within the scope of the present invention.

In this example, conferees C1, C2, and C3 may speak into respective communication devices 502, 504, and 506 in English, Spanish, and German respectively, as part of teleconference 510. The speech of the conferees may be sequential, or the speech segments of the conferees may overlap to some extent, as sometimes happens in group discussions. The system and method of the present invention can process either combination of speech contributions from the respective conferees.

Continuing with the example, the respective speech segments of the conferees may then be transcribed into text using STT transcription engine 404. Preferably, each speech segment is transcribed using a program within engine 404 suited to the language in which the conferee original speech segment was spoken in. Thereafter, the respective transcribed translated speech segments may be sent to text-to-text translation engine 402.

Translation engine 402 preferably generates a separate output for each of the three languages being used in teleconference 510. Thus, for each target language, within the context of translation engine 510, one of the three incoming streams of speech may already be in the target language, while streams of speech from the other two conferees will generally need to be translated. Thus, translation engine 402 preferably generates three separate monolingual streams of translated speech—one for each conferee participating in teleconference 510.

Next, the three separate streams of conference text may be transcribed into three respective streams of monolingual uttered speech using TTS engine 406. Thereafter, transcribed, monolingual streams of conference audio may be transmitted to the communication devices 502, 504, and 506 of the respective conferees in the languages designated for the respective conferees. The combined monolingual conference audio in the respective languages is designated in FIG. 5 using the notations: C1/C2/C3 English; C1/C2/C3 Spanish; and C1/C2/C3 German.

A method according to the present invention may employ one of several mechanisms for establishing the language to be used for each conferee. In one embodiment, the method may map caller IDs (identifications) of the conference participants to respective languages of the conferees based on a pre-existing association between the regions and the respective languages. In another embodiment, a succession of keys may be entered, for each participant, to define a source language and a target language for that participant in a conference call.

In one embodiment, data in addition to user-uttered speech may be transcribed and translated as part of a conference call. For instance, in one embodiment, an object such as a sign, sports equipment, a hand gesture such as by a hearing impaired person, or image may be captured by a camera, converted into text indicative of the graphic data obtained by the camera, and subsequently transcribed, translated, and transcribed into audio, and streamed all participants in the teleconference, along with other text arising from ongoing audio discussions forming part of the teleconference.

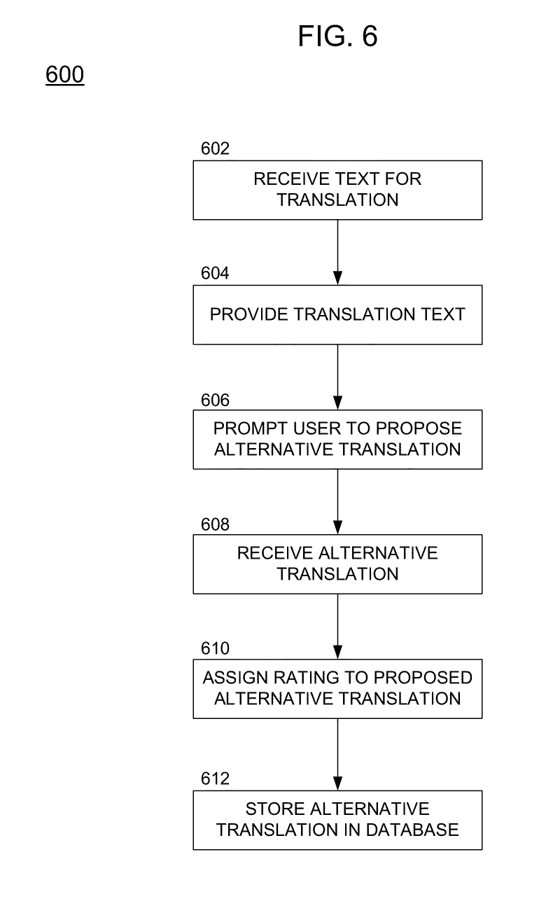

FIG. 6 is a flow diagram of a method 600 for updating translations in a database in accordance with an embodiment of the present invention. In this embodiment, method 600 may be based on a human assisted one-to-one mapping storage scheme of the text corpus. At step 602, the system may receive text for translation from the user. At step 604, the system 400 may provide translation text in a target language corresponding to the source-language text provided by the user in step 602.

At step 606, the system 400 may prompt the user to propose an alternative translation to that initially generated from system 400 in step 604. The user may generate an alternative translation of his or her own, or the user may be provided with a set of alternative translations by system 400, along with the main translation proposed by system 400. The user may select (608) the most accurate translation among the alternatives and rate (610) the selected translation. The ratings could, for instance, include rating terms such as” “accurate”; “satisfactory”; “needs improvement”; and “weak”. However, the invention is not limited to the listing of ratings provided above. A ratings system having fewer or more rating levels than those listed above may be provided.

In one embodiment, a rating deemed to be “accurate” could correspond to a range of numerical rating of 90% or above; “satisfactory” could correspond to a numerical rating range of 85%-89%; “needs improvement” could correspond to a numerical rating range of 76% to 84%; and “weak” could correspond to a numerical rating range of 75% and below.

The alternative translation option rated by the user in step 610 may be stored (612) in a database. For each option rated from different users, a weighted mean value may be calculated. The option with the highest weighted mean value may replace all others, if it exceeds a defined threshold.

The weight of the rating accorded to a proposed translation may be based on the rank of the user providing the translation (i.e., the higher a rank of a user, the more weight will be awarded to the given rating) when calculating the weighted mean value. The rating values, of proposed translations, for calculating the weighted mean values, of proposed translations, may be established according to the following: 95% for accurate; 87% for satisfactory; 80% for needs improvement; and 75% for weak. Ranks (of users) may have numerical values between 0 and 10 and may correspond to weights from 0-100%. Supposing three users A, B and C of rank 1, 8 and 10, respectively, rate a particular alternative as accurate (95%), satisfactory (87%) and needs improvement (80%), respectively. Weights are taken as 10, 80 and 100, so calculating by

$$\overline{x} = \frac{{\sum }_{i = 1}^{n} {w}_{i} {x}_{i}}{{\sum }_{i = 1}^{n} {w}_{i}} ,$$

which leads to

[10(95) (user A)+80(87) (user B)+100(80) (user C)]/[(10+80+100)]=83.7% (falls in the range 76%-84%)

A ranking system may be used for the users, based on the accuracy rating of a given user. The accuracy rating of a user may be determined based on the number of alternative translations ratings provided the user that fall within the same range as the weighted mean value of those alternatives, divided by the total number of alternatives rated by a user.

For example, we assume that a new user X starts with a rank of 0. We consider a case in which an alternative translation is rated as accurate (in range 90% and above). If user X also rates the translation as “accurate,” the user X rank will be increased to a rank of 1. If the user rates nine (9) more alternative translations, and rates seven of the translations correctly (i.e. assigns the same rating that the majority of other users did), i.e. gets seven right and two wrong, the user may be assigned an accuracy of 80%. The process of ranking of the user may be conducted once the user has rated a certain minimum number of alternative translations. This minimum number of alternative translations may be set to any desired number, such as 10, 30, 50, any number in between 10 and 50, or a number below 10, or greater than 50. When ranking the user, ranking levels may be assigned according to the schedule: rank 10 for 90%-100% accuracy; rank 9 for 80%-89% accuracy; rank 8 for 70-79% accuracy; rank 7 for 60-69% accuracy; rank 6 for 50-59% accuracy; rank 5 for 40-49% accuracy; rank 4 for 30-39% accuracy; rank 3 for 20-29% accuracy; rank 2 for 10-19% accuracy; and rank 1 for 0%-9% accuracy.

Using the practices described above, the algorithm described above may store and update data, on an ongoing basis, in a parallel corpora method i.e. one-to-one mapping for each text-to-text translation pair, in the database. A Hash function may be used to generate and store hashes against for text, in order to ensure fast retrievals, insertions, and updates, given the large size of the database.

It is noted that the methods and apparatus described thus far and/or described later in this document may be achieved utilizing any of the known technologies, such as standard digital circuitry, analog circuitry, any of the known processors that are operable to execute software and/or firmware programs, programmable digital devices or systems, programmable array logic devices, or any combination of the above. One or more embodiments of the invention may also be embodied in a software program for storage in a suitable storage medium and execution by a processing unit.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. A method of improving a translation system, the method comprising the steps of:
presenting initial text in a source language and a corresponding translation text sequence in a target language, to a user on a computing device;
prompting the user to propose alternative text for at least a portion of the translation text sequence;
receiving proposed alternative translation text from the user;
assigning a rating, by the user, to the proposed alternative translation text; and
storing the received proposed translation text in a database.

2. The method of claim 1 wherein the step of prompting consists of one of the group consisting of: (a) presenting, to the user, one or more alternative translations in addition to the presented translation text sequence; and (b) inviting the user to draft text to replace the portion of the translation text sequence.

3. The method of claim 1 further comprising:
assigning a rank to the user; and
according weight to the user rating of the proposed alternative translation text based on the rank of the user.

4. The method of claim 3 wherein the step of assigning a rank to the user comprises:
granting a rank to 0 to the user when the user is new to the ranking system.

5. The method of claim 4 wherein the step of assigning further comprises:
supplementing the rank of the user when the user provides a rating to an alternative translation that is in agreement with ratings provided to the alternative translation by a weighted average of other users.

6. The method of claim 5 further comprising:
storing (a) rating data for translation text segments and (b) rank data for one or more users in a database.

7. The method of claim 6 further comprising:
updating (a) said rating data for translation text segments and (b) said rank data for one or more users in the database, whenever additional rating data/rank data is obtained by the method.

8. A method for ranking a user of a translation system implemented on a computer system, the method comprising the steps of:
providing an initial ranking to a user of the translation system;
assigning a rating, by the user, to a translation of text from a source language to a target language; and
incrementing, with a processor within said computer system, the initial ranking if the rating of the translation assigned by the user agrees with a consensus of prior ratings accorded to the translation.

9. The method of claim 8 further comprising:
providing an initial ranking of “0” to a user;
incrementing the ranking to “1” if the user assigns a rating to a selected translation that is in agreement with ratings for the selected translation previously provided by a plurality of other users.

10. The method of claim 8 further comprising:
establishing a schedule associating the rank of a user with a measure of the accuracy of the user's ratings of translations, using the computer system;
storing the established schedule in a computer memory in communication with said computer system;
identifying a level of correspondence between the ratings of selected translations generated by the user and ratings of the selected translations previously generated by a plurality of other users; and
determining a rank for the user based on the identified level of correspondence and the established schedule.
